(19) United States
(12) Patent Application Publication
(10) Pub. No.: US 2022/0327932 A1
(43) Pub. Date: Oct. 13, 2022

(54) DANGEROUS DRIVING VEHICLE ALERT SYSTEM, DANGEROUS DRIVING VEHICLE ALERT DEVICE AND DANGEROUS DRIVING VEHICLE ALERT PROGRAM, AND COMPUTER-READABLE STORAGE MEDIUM OR STORAGE DEVICE STORING THE PROGRAM

(71) Applicant: SANYO Electric Co., Ltd., Osaka (JP)

(72) Inventor: Satoshi NAKAYA, OSAKA FU (JP)

(21) Appl. No.: 17/638,653

(22) PCT Filed: Aug. 5, 2020
(86) PCT No.: PCT/JP2020/029910

§ 371 Date: Feb. 25, 2022

(30) Foreign Application Priority Data
Aug. 29, 2019 (JP) 2019-156938

(51) Int. Cl. G08G 1/16; G08G 1/13; H04W 4/44

(52) U.S. Cl. CPC G08G 1/16; G08G 1/13; H04W 4/44

(57) ABSTRACT

A server includes a dangerous driving level calculator and a server-side communicator. The calculator analyzes patterns of driving behavior of analyzed vehicles that are included in data of images based on sent-to-server data to calculate dangerous driving levels of the analyzed vehicles, and compares the levels of the analyzed vehicles with a predetermined value to categorize each analyzed vehicle into a danger vehicle if its level is higher than the predetermined value. The server-side communicator transmits sent-to-vehicle data to vehicle-side communicators of alerted vehicles at second predetermined timing, and receives the sent-to-server data at first timing. The sent-to-vehicle data includes the level of the danger vehicle and positional information that represents a position at which an image of the danger vehicle is captured. The level of the danger vehicle can be indicated on road maps on vehicle-side displays of the alerted vehicles in accordance the position of the danger vehicle.

### CROSS-REFERENCE TO RELATED APPLICATIONS

This application is the U.S. National Phase under 35 U.S.C. 371 of International Patent Application No. PCT/JP2020/029910, filed on Aug. 5, 2020, which in turn claims the benefit of Japanese Application No. 2019-156938, filed on Aug. 29, 2019, the entire disclosures of which applications are incorporated by reference herein

### BACKGROUND

The present disclosure relates to a dangerous driving vehicle alert system, a dangerous driving vehicle alert device and a dangerous driving vehicle alert program, and a computer-readable storage medium or storage device storing the dangerous driving vehicle alert program.

Societal issues arise in various places from unpredictable behaviors, such as road rage and dangerous driving, exhibited by motorists. Such unpredictable motorist behaviors sometimes cause accidents that make usual motorists victims. The number of such accidents is increasing in recent years. Even a careful motorist, who pays attention to surrounding traffic, cannot predict personalities or habits of other motorist in the surrounding traffic. From this viewpoint, no motorist may avoid a sudden scary experience, incident, or accident.

Such societal issues will also arise from self-driving cars in the days in which self-driving and human-driving cars run on roads because behaviors of self-driving and human-driving cars will be different. Even if motorists watch and pay attention to surrounding traffic, danger brought by these unpredictable behaviors is hardly avoidable for them.

It is an object of the present disclosure to provide a dangerous driving vehicle alert system, a dangerous driving vehicle alert device and a dangerous driving vehicle alert program capable of reliably providing safety from danger brought by vehicles that run in surrounding traffic, and a computer-readable storage medium or storage device storing the dangerous driving vehicle alert program.

### SUMMARY

A dangerous driving vehicle alert system according to an aspect of the present disclosure issues alert relating to a potential dangerous driving vehicle to a plurality of alert-receiving vehicles. The system includes a server, vehicle-side sensors, vehicle-side displays, vehicle-mounted cameras, vehicle-side storages, and vehicle-side communicators. The vehicle-side sensors are included in the alert-receiving vehicles, and detect positions of the alert-receiving vehicles. The vehicle-side displays are included in the alert-receiving vehicles, and show road maps of areas around the alert receiving vehicles. The vehicle-mounted cameras are included in the alert-receiving vehicles, and capture images corresponding to FOVs of the vehicle-mounted cameras on the alert-receiving vehicles. The vehicle-side storages are included in the alert-receiving vehicles, and save data of images that are captured by the vehicle-mounted cameras on the alert-receiving vehicles. The vehicle-side communicators are included in the alert-receiving vehicles. The vehicle-side communicators can transmit sent-to-server data to a server at predetermined first timing, and receive sent-to-vehicle data from the server. The sent-to-server data includes the data of images, which is saved in the vehicle-side storages, and positional information that is detected by the vehicle-side sensors of the alert-receiving vehicles and represents image capture positions. The images are captured at the image capture positions. The server can be connected to the alert receiving vehicles through the vehicle-side communicators of the alert receiving vehicles. The server includes a dangerous driving level calculator and a server-side communicator. The dangerous driving level calculator analyzes patterns of driving behavior of vehicles to be analyzed that are included in the data of images based on the sent-to-server data to calculate dangerous driving levels of the vehicles analyzed. The dangerous driving level also compares the dangerous driving levels calculated of the vehicles to be analyzed with a predetermined value to categorize each vehicle to be analyzed into a dangerous driving vehicle if its dangerous driving level is higher than the predetermined value. The server-side communicator transmits the sent-to-vehicle data to vehicle-side communicators of the alert receiving vehicles at predetermined second timing, and receives the sent-to-server data from the vehicle-side communicators at the first timing. The sent-to-vehicle data includes the dangerous driving level of the dangerous driving vehicle, which is calculated by the dangerous driving level calculator, and positional information that represents a position at which an image of the dangerous driving vehicle is captured. The dangerous driving level of the dangerous driving vehicle, which is included in the sent-to-server data, can be indicated on the road maps on the vehicle-side displays of the alert receiving vehicles in accordance the position of the dangerous driving vehicle.

The aforementioned dangerous driving vehicle alert system can inform alert receiving vehicles to be used in the dangerous driving vehicle display system of existence of a potential dangerous driving vehicle, which can cause accidents, and its position. Conventional systems do not allow motorists to know such a dangerous driving vehicle unless they can directly see unsafe behaviors of the dangerous driving vehicle. For this reason, before seeing unsafe behaviors, motorists avoid neither approaching dangerous driving vehicles nor choosing an alternative path. Contrary to this, motorists who use the aforementioned system can know existence of a potential dangerous driving vehicle even when not seeing the vehicle. As a result, they can avoid approaching the vehicle. Consequently, they can safely drive their vehicles. Therefore, the aforementioned system can reduce or prevent the risk of incidents and accidents caused by potential dangerous driving vehicles.

### BRIEF DESCRIPTION OF DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic view showing a dangerous driving vehicle alert system;

FIG. 2 is a block diagram showing exemplary components of an alert receiving vehicle;

FIG. 3 is a schematic plan view showing image capture areas of vehicle-mounted cameras of the alert receiving vehicle;

FIG. 4 is a block diagram showing exemplary components of a server;

FIG. 5 is a schematic view showing a dangerous driving vehicle alert system according to a second embodiment;

FIG. 6 is a schematic block diagram showing the dangerous driving vehicle alert system shown in FIG. 5;

FIGS. 7A and 7B are schematic vehicle and image tables on a cloud-side, respectively;

FIG. 8 is a flowchart showing operations in the dangerous driving vehicle alert system shown in FIG. 5;

FIG. 9 is a schematic view showing an exemplary indication of a dangerous driving vehicle on a vehicle-side display; and

FIG. 10 is a schematic view showing another exemplary indication of dangerous driving vehicles, which run around a vehicle to be alerted, on a vehicle-side display.

### DESCRIPTION

A dangerous driving vehicle alert system according to the foregoing aspect of the present disclosure can have the following features.

A dangerous driving vehicle alert system according to another aspect of the present disclosure further includes dangerous driving vehicle extractors that are included in the alert receiving vehicles and analyze patterns of driving behavior of vehicles to be analyzed that are included in the data of images, which are captured by the vehicle-mounted cameras on the alert-receiving vehicles, based on the data of images to extract a dangerous driving vehicle that exhibits a predetermined dangerous behavior. The sent-to-server data includes information relating to the dangerous driving vehicle that is extracted by the dangerous driving vehicle extractor. The server calculates a dangerous driving level of the dangerous driving vehicle that is extracted by the dangerous driving vehicle extractor by using the dangerous driving level calculator. In the aforementioned dangerous driving vehicle alert system, when the alert receiving vehicle extracts a dangerous driving vehicle, the server can calculate a dangerous driving level of the dangerous driving vehicle. As a result, this system can efficiently operate.

In a dangerous driving vehicle alert system according to another aspect of the present disclosure, in addition to the aforementioned aspect, the first timing is the time of extraction of the dangerous driving vehicle by the dangerous driving vehicle extractor. In the aforementioned dangerous driving vehicle alert system, when each alert receiving vehicle extracts a dangerous driving vehicle, it transmits sent-to-server data to the server. As a result, the server can efficiently calculate a dangerous driving level of the dangerous driving vehicle.

Also, in a dangerous driving vehicle alert system according to another aspect of the present disclosure, in addition to the aforementioned aspect, the first timing is a predetermined cycle. In the aforementioned dangerous driving vehicle alert system, because each alert receiving vehicle periodically transmits sent-to-server data to the server, the server can centralize information relating to dangerous driving vehicles. As a result, load of calculation in each alert receiving vehicle can be light.

Also, in a dangerous driving vehicle alert system according to another aspect of the present disclosure, in addition to any of the aforementioned aspects, the server further includes a vehicle registration plate reader that extracts from the dangerous driving vehicle, which is included in the data of images, its vehicle registration plate, and reads its identifier from the vehicle registration plate to obtain vehicle identifier information. The server transmits sent-to-vehicle data that includes the vehicle identifier information, which is obtained by the vehicle registration plate reader, to the alert receiving vehicles. The alert receiving vehicles can indicate the vehicle identifier information, which is included in the sent-to-vehicle data, on their vehicle-side displays. In the aforementioned dangerous driving vehicle alert system, because the server obtains vehicle identifier information relating to a dangerous driving vehicle, the server can inform motorists who drive the alert receiving vehicles of the vehicle identifier information. Consequently, the motorists can watch the dangerous driving vehicle, which is specified by the vehicle identifier information.

Also, in a dangerous driving vehicle alert system according to another aspect of the present disclosure, in addition to any of the aforementioned aspects, the data of images includes moving images. In the aforementioned dangerous driving vehicle alert system, it can be determined whether to categorize a series of behaviors of a vehicle to be analyzed to dangerous driving based on analysis of moving images of the vehicle.

Also, in a dangerous driving vehicle alert system according to another aspect of the present disclosure, in addition to the right above aspect, the data of images that includes moving images is compressed and transmitted between the vehicle-side and server-side communicators. In the aforementioned dangerous driving vehicle alert system, data compression of moving images before transmission can reduce an amount of communication data to enhance high speed and light load communication.

Also, in a dangerous driving vehicle alert system according to another aspect of the present disclosure, in addition to any of the aforementioned aspects, the vehicle-side and server-side communicators transmit data from one to another via a public communication network. Because the aforementioned dangerous driving vehicle alert system uses communication via an existing public communication network, data can be easily and inexpensively transmitted in wide areas.

Also, in a dangerous driving vehicle alert system according to another aspect of the present disclosure, in addition to any of the aforementioned aspects, the vehicle-mounted camera captures images of a forward, rearward, and/or sideways area(s) of the alert receiving vehicle. In the aforementioned dangerous driving vehicle alert system, because images of a plurality of vehicles in forward, rearward, and/or sideways area(s) of each alert receiving vehicle can be captured and be included in image data, data of such vehicles can be efficiently collected.

Also, in a dangerous driving vehicle alert system according to another aspect of the present disclosure, in addition to any of the aforementioned aspects, the dangerous driving level calculator calculates a dangerous driving level by using artificial intelligence (AI) based on the data of images of the dangerous driving vehicle. In the aforementioned dangerous driving vehicle alert system, a large number of feature quantities can be extracted from image data and be used to efficiently and objectively classify a dangerous driving vehicle to dangerous driving levels.

Also, in a dangerous driving vehicle alert system according to another aspect of the present disclosure, in addition to any of the aforementioned aspects, the dangerous driving level calculator determines based on patterns of driving behavior of each vehicle to be analyzed at least one of conditions whether it suddenly brakes, whether abrupt steering input is applied to it, whether it violates a safety distance between vehicles, how often it makes a lane change, whether it honks its horn, whether it uses headlight flashing, whether it repeatedly drifts out of its lane, whether it goes the wrong way and whether it runs a red light as at least one parameter, and assigns a weight(s) to the at least one parameter to determine whether to categorize it into a dangerous driving vehicle. In the aforementioned dangerous driving vehicle alert system, because examples of dangerous behaviors are previously defined and are given weights depending on danger degrees of the dangerous behaviors to classify a dangerous driving vehicle to dangerous driving levels, objective categorization can be provided based on the examples of dangerous behaviors.

Also, in a dangerous driving vehicle alert system according to another aspect of the present disclosure, in addition to any of the aforementioned aspects, the vehicle-side sensor includes at least one of a GPS sensor, a gyro sensor, and an accelerometer. The vehicle-side sensor is included in a smartphone or tablet that can be placed in the alert receiving vehicle, and the vehicle-side display is a screen of a map application that can be displayed on a display of the smartphone or tablet, which can be placed in the alert receiving vehicle. The dangerous driving vehicle alert system that uses smartphones or tablets can be inexpensively provided.

Also, in a dangerous driving vehicle alert system according to another aspect of the present disclosure, in addition to any of the aforementioned aspects, the server is one of a plurality of servers, which are distributed to cover predetermined areas. This dangerous driving vehicle alert system further includes a cloud server that can be connected to the plurality of servers to transmit data between the cloud server and the plurality of servers, and collect and save sent-to-vehicle data and sent-to-server data that are sent/received by the plurality of servers. In the aforementioned dangerous driving vehicle alert system, edge computing is realized by servers that are distributed in areas and cover operations in their areas, and a cloud server that entirely manages data in the system. As a result, delays can be reduced. Also, because operations are distributed, the operations can be efficiently performed. In addition, because data or operations can be backed up, the system can reliably operate.

A dangerous driving vehicle alert server according to another aspect of the present disclosure can be used in a dangerous driving vehicle alert system that issues alert relating to a potential dangerous driving vehicle to alert-receiving vehicles. The server includes a server-side communicator and a dangerous driving level calculator. The server-side communicator receives sent-to-server data that is transmitted from vehicle-side communicators, which are included in the alert receiving vehicles, at predetermined first timing and transmits sent-to-vehicle data to the vehicle-side communicators of the alert receiving vehicles at predetermined second timing. The sent-to-server data includes data of images that is saved in vehicle-side storages, which are included in the alert receiving vehicles, and positional information that is detected by vehicle-side sensors, which are included in the alert-receiving vehicles, and represents image capture positions at which the images are captured. The dangerous driving level calculator analyzes patterns of driving behavior of vehicles to be analyzed that are included in the data of images, which is saved in the vehicle-side storages, based on the sent-to-server data to calculate dangerous driving levels of the vehicles analyzed. Also, the dangerous driving level calculator compares the dangerous driving levels calculated of the vehicles to be analyzed with a predetermined value to categorize each vehicle to be analyzed into a dangerous driving vehicle if its dangerous driving level is higher than the predetermined value. The sent-to-vehicle data includes the dangerous driving level of the dangerous driving vehicle, which is calculated by the dangerous driving level calculator, an identifier of a vehicle registration plate of the dangerous driving vehicle extracted from the data of images, and positional information that represents a position at which an image of the dangerous driving vehicle is captured. The sent-to-vehicle data includes the dangerous driving level of the dangerous driving vehicle, which is calculated by the dangerous driving level calculator, an identifier of a vehicle registration plate of the dangerous driving vehicle extracted from the data of images, and positional information that represents a position at which an image of the dangerous driving vehicle is captured. The dangerous driving level of the dangerous driving vehicle and the identifier of the dangerous driving vehicle, which are included in the sent-to-server data, can be indicated on road maps on the vehicle-side displays of the alert receiving vehicles in accordance the position of the dangerous driving vehicle. The aforementioned dangerous driving vehicle alert server allows motorists who drive alert receiving vehicles to be used in the dangerous driving vehicle alert system to know existence of a potential dangerous driving vehicle, which can cause accidents, and its position. Conventional systems do not allow motorists to know such a dangerous driving vehicle unless they can directly see unsafe behaviors of the dangerous driving vehicle. For this reason, before seeing unsafe behaviors, motorists avoid neither approaching dangerous driving vehicles nor choosing an alternative path. Contrary to this, motorists who use the aforementioned system can know existence of a potential dangerous driving vehicle even when not seeing the vehicle. As a result, they can avoid approaching the vehicle. Consequently, they can safely drive their vehicles. Therefore, the aforementioned system can reduce or prevent the risk of incidents and accidents caused by potential dangerous driving vehicles.

A dangerous driving vehicle alert device according to another aspect of the present disclosure can issue alert relating to a potential dangerous driving vehicle. The device includes a vehicle-side sensor, a vehicle-side display, a vehicle-mounted camera, a vehicle-side storage, and a vehicle-side communicator. The vehicle-side sensor can detect a position of a vehicle to be alerted. The vehicle-side display can show a road map of an area around the vehicle to be alerted. The vehicle-mounted camera captures images corresponding to an FOV of the vehicle-mounted camera on the vehicle to be alerted. The vehicle-side storage saves data of images that are captured by the vehicle-mounted camera. The vehicle-side communicator can transmit sent-to-server data to a server to be used in a dangerous driving vehicle alert system at predetermined first timing and receive sent-to-vehicle data from the server. The sent-to-server data includes the data of images, which is saved in the vehicle-side storages, and positional information that is detected by the vehicle-side sensor and represents an image capture position at which the images are captured. Patterns of driving behavior of vehicles to be analyzed that are included in the data of images are analyzed based on the sent-to-server data to calculate dangerous driving levels of the vehicles analyzed so that the dangerous driving levels calculated of the vehicles to be analyzed are compared with a predetermined value to categorize each vehicle to be analyzed into a dangerous driving vehicle if its dangerous driving level is higher than the predetermined value. The vehicle-side communicator receives the sent-to-vehicle data including the dangerous driving level of the dangerous driving vehicle, an identifier of a vehicle registration plate of the dangerous driving vehicle extracted from the data of images, and positional information that represents a position at which an image of the dangerous driving vehicle is captured. The dangerous driving level and the identifier can be indicated on the road map on the vehicle-side display in accordance the position of the dangerous driving vehicle. The aforementioned dangerous driving vehicle alert device allows motorists who who drive alert receiving vehicles alert receiving vehicles to be used in the dangerous driving vehicle alert system to know existence of a potential dangerous driving vehicle, which can cause accidents, and its position. Conventional systems do not allow motorists to know such a dangerous driving vehicle unless they can directly see unsafe behaviors of the dangerous driving vehicle. For this reason, before seeing unsafe behaviors, motorists avoid neither approaching dangerous driving vehicles nor choosing an alternative path. Contrary to this, motorists who use the aforementioned system can know existence of a potential dangerous driving vehicle even when not seeing the vehicle. As a result, they can avoid approaching the vehicle. Consequently, they can safely drive their vehicles. Therefore, the aforementioned system can reduce or prevent the risk of incidents and accidents caused by potential dangerous driving vehicles.

A dangerous driving vehicle alert method according to another aspect of the present disclosure is a method of issuing alert relating to a potential dangerous driving vehicle to a plurality of alert-receiving vehicles. The method includes image data saving, sent-to-server data transmission, pattern analysis, sent-to-vehicle data transmission, and alert indication. Data of images that are captured by vehicle-mounted cameras is saved in vehicle-side storages that are included in the alert-receiving vehicles in the image data saving. The vehicle-mounted cameras are included in the alert-receiving vehicles. Sent-to-server data is transmitted to a server to be used in a dangerous driving vehicle alert system at predetermined first timing in the sent-to-server data transmission. The sent-to-server data includes the data of images, which is saved in the vehicle-side storages, and positional information that is detected by vehicle-side sensors and represents image capture positions at which the images are captured. The vehicle-side sensors are included in the alert-receiving vehicles. Patterns of driving behavior of vehicles to be analyzed that are included in the data of images are analyzed based on the sent-to-server data to calculate dangerous driving levels of the vehicles analyzed. The dangerous driving levels calculated of the vehicles to be analyzed is compared with a predetermined value to categorize each vehicle to be analyzed into a dangerous driving vehicle if its dangerous driving level is higher than the predetermined value by using a dangerous driving level calculator in the pattern analysis. Sent-to-vehicle data is transmitted to the alert receiving vehicles at predetermined second timing in the sent-to-vehicle data transmission. The sent-to-vehicle data includes the dangerous driving level of the dangerous driving vehicle, which is calculated by the dangerous driving level calculator, an identifier of a vehicle registration plate of the dangerous driving vehicle extracted from the data of images, and positional information that represents a position at which an image of the dangerous driving vehicle is captured. The dangerous driving level and the identifier of the dangerous driving vehicle, which are included in the sent-to-vehicle data, can on road maps, which show areas around the alert receiving vehicles, are indicated on the vehicle-side displays of the alert receiving vehicles in accordance the position of the dangerous driving vehicle in the alert indication. The aforementioned dangerous driving vehicle alert method can inform alert receiving vehicles to be used in the dangerous driving vehicle display system of existence of a potential dangerous driving vehicle, which can cause accidents, and its position. Motorists cannot know such a dangerous driving vehicle in conventional systems unless they directly see unsafe behaviors of the dangerous driving vehicle. For this reason, before seeing unsafe behaviors, motorists avoid neither approaching dangerous driving vehicles nor choosing an alternative path. Contrary to this, motorists who use the aforementioned system can know existence of a potential dangerous driving vehicle even when not seeing the vehicle. As a result, they can avoid approaching the vehicle. Consequently, they can safely drive their vehicles. Therefore, the aforementioned system can reduce or prevent the risk of incidents and accidents caused by potential dangerous driving vehicles.

A server program according to another aspect of the present disclosure is a program of realizing a dangerous driving vehicle alert system that issues alert relating to a potential dangerous driving vehicle to alert-receiving vehicles. The program causes a server to execute sent-to-server-data reception, pattern analysis (dangerous driving level calculation), and sent-to-vehicle-data transmission. Sent-to-server data is received in the sent-to-server-data reception. The sent-to-server data is transmitted from vehicle-side communicators, which are included in the alert receiving vehicles, at predetermined first timing. The sent-to-server data includes data of images that is saved in the vehicle-side storages, which are included in the alert receiving vehicles, and positional information that is detected by vehicle-side sensors, which are included in the alert-receiving vehicles, and represents image capture positions at which the images are captured. Patterns of driving behavior of vehicles to be analyzed that are included in the data of images are analyzed based on the sent-to-server data to calculate dangerous driving levels of the vehicles analyzed in the pattern analysis. The data of images is saved in vehicle-side storages. The vehicle-side storages are included in the alert receiving vehicles. In the pattern analysis, the dangerous driving levels calculated of the vehicles to be analyzed are compared with a predetermined value to categorize each vehicle to be analyzed into a dangerous driving vehicle if its dangerous driving level is higher than the predetermined value. Sent-to-vehicle data is transmitted to the alert receiving vehicles at predetermined second timing in the sent-to-vehicle-data transmission. The sent-to-vehicle data includes the dangerous driving level of the dangerous driving vehicle, which is calculated in the analyzing of patterns of driving behavior, an identifier of a vehicle registration plate of the dangerous driving vehicle extracted from the data of images, and positional information that represents a position at which an image of the dangerous driving vehicle is captured. The sent-to-vehicle data transmission can cause the vehicle-side displays of the alert receiving vehicles to indicate the dangerous driving level and the identifier of the dangerous driving vehicle, which are included in the sent-to-vehicle data, on road maps in accordance the position of the dangerous driving vehicle. The road maps show areas around the alert receiving vehicles. The aforementioned server program can inform alert receiving vehicles to be used in the dangerous driving vehicle display system of existence of a potential dangerous driving vehicle, which can cause accidents, and its position. Motorists cannot know such a dangerous driving vehicle in conventional systems unless they directly see unsafe behaviors of the dangerous driving vehicle. For this reason, before seeing unsafe behaviors, motorists avoid neither approaching dangerous driving vehicles nor choosing an alternative path. Contrary to this, motorists who use the aforementioned system can know existence of a potential dangerous driving vehicle even when not seeing the vehicle. As a result, they can avoid approaching the vehicle. Consequently, they can safely drive their vehicles. Therefore, the aforementioned system can reduce or prevent the risk of incidents and accidents caused by potential dangerous driving vehicles.

A dangerous driving vehicle alert program according to another aspect of the present disclosure is a program of issuing alert relating to a potential dangerous driving vehicle. The program causes a computer to execute image data saving, sent-to-server data transmission, sent-to-vehicle data reception, and alert indication. Data of images is saved in the image data saving. The images are captured corresponding to an FOV of a vehicle-mounted camera on the vehicle to be alerted. Sent-to-server data is transmitted to a server to be used in a dangerous driving vehicle alert system at predetermined first timing, and sent-to-vehicle data from the server is received in the data transmission. The sent-to-server data includes the data of images captured, and positional information that is detected by a vehicle-side sensor and represents an image capture position at which the images are captured. The vehicle-side sensor detects a position of the vehicle to be alerted. Sent-to-vehicle data is received in the sent-to-vehicle data reception. The sent-to-vehicle data includes a dangerous driving level of a dangerous driving vehicle that is calculated based on pattern analysis, an identifier of a vehicle registration plate of the dangerous driving vehicle extracted from the data of images, and positional information that represents a position at which an image of the dangerous driving vehicle is captured. The pattern analysis analyzes patterns of driving behavior of vehicles to be analyzed that are included in the data of images based on the sent-to-server data to calculate dangerous driving levels of the vehicles analyzed so that the dangerous driving levels calculated of the vehicles to be analyzed are compared with a predetermined value to categorize each vehicle to be analyzed into the dangerous driving vehicle if its dangerous driving level is higher than the predetermined value. The dangerous driving level and the identifier of the dangerous driving vehicle can be indicated in response to the reception of the sent-to-vehicle data from the server through vehicle-side communicator on a road map on a vehicle-side display in accordance the position of the dangerous driving vehicle. The road map shows an area around the vehicle to be alerted in the alert indication. The aforementioned dangerous driving vehicle alert program can inform alert receiving vehicles to be used in the dangerous driving vehicle display system of existence of a potential dangerous driving vehicle, which can cause accidents, and its position. Motorists cannot know such a dangerous driving vehicle in conventional systems unless they directly see unsafe behaviors of the dangerous driving vehicle. For this reason, before seeing unsafe behaviors, motorists avoid neither approaching dangerous driving vehicles nor choosing an alternative path. Contrary to this, motorists who use the aforementioned system can know existence of a potential dangerous driving vehicle even when not seeing the vehicle. As a result, they can avoid approaching the vehicle. Consequently, they can safely drive their vehicles. Therefore, the aforementioned system can reduce or prevent the risk of incidents and accidents caused by potential dangerous driving vehicles.

A non-transitory computer readable recording medium or storage device according to a still another aspect of the present disclosure includes the aforementioned program. The storage medium can be CD-ROM, CD-R, CD-RW, flexible disk, magnetic tape, MO, DVD-ROM, DVD-RAM, DVD−R, DVD+R, DVD−RW, DVD+RW, Blu-ray (registered trademark), magnetic disk such as HD DVD (AOD), optical disc, magneto-optical disk, semiconductor memory, other medium that can store the program. The program can be distributed in a form stored in the storage medium, and be also distributed through network such as the Internet (downloaded). The storage medium can include a device that can store the program, for example, a general-purpose device or special-purpose device on which the aforementioned program is installed in a form of executable software, firmware or the like. Processes or functions included in the program can be executed by the program software that can be executed by a computer. The processes of parts can be realized by hardware such as certain gate array (FPGA, ASIC, DSP), or a form of combination of program software and partial hardware module that realizes parts of elements of hardware.

The following description will describe embodiments according to the present disclosure with reference to the drawings. It should be appreciated, however, that the embodiments described below are illustrations of a dangerous driving vehicle alert system, a dangerous driving vehicle alert device and a dangerous driving vehicle alert program, and a computer-readable storage medium or storage device storing the dangerous driving vehicle alert program to give a concrete form to technical ideas of the disclosure, and a dangerous driving vehicle alert system, a dangerous driving vehicle alert device and a dangerous driving vehicle alert program, and a computer-readable storage medium or storage device storing the dangerous driving vehicle alert program of the disclosure are not specifically limited to description below. Furthermore, it should be appreciated that the components shown in claims attached hereto are not specifically limited to components in the embodiments. Unless otherwise specified, any dimensions, materials, shapes and relative arrangements of the components described in the embodiments are given as an example and not as a limitation. Additionally, the sizes and the positional relationships of the components in each of drawings are occasionally shown exaggeratingly for ease of explanation. Components same as or similar to those of this present disclosure are attached with the same designation and the same reference signs, and their description is omitted. In addition, a plurality of structural elements of the present disclosure can be configured as a single part that serves the purpose of a plurality of elements, on the other hand, a single structural element can be configured as a plurality of parts that serve the purpose of a single element. Also, the description of some of examples or embodiments may be applied to other examples, embodiments or the like.

### First Embodiment

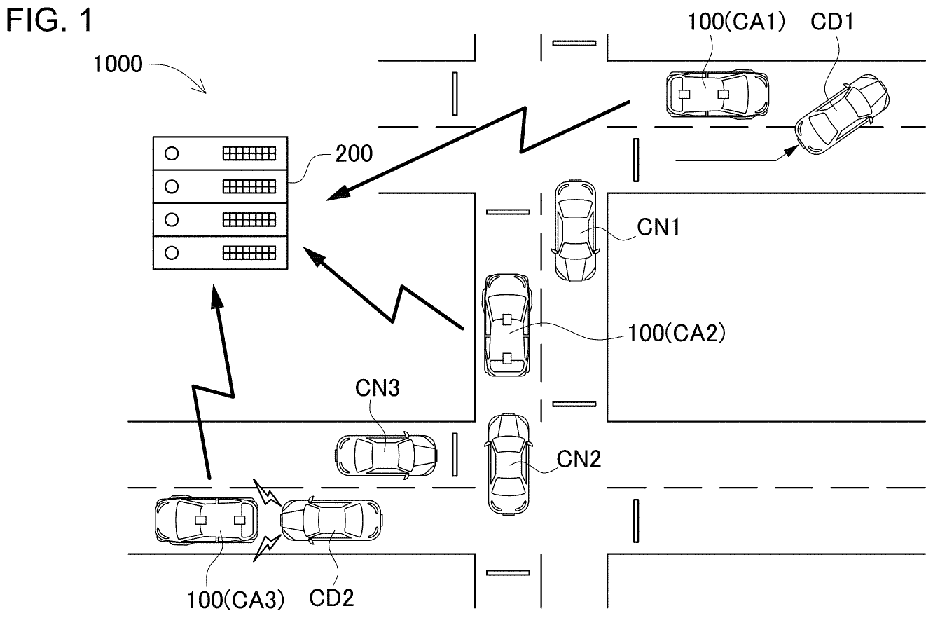

A dangerous driving vehicle alert system 1000 according to a first embodiment is now described with reference to FIG. 1. The dangerous driving vehicle alert system 1000 includes a server 200 and a number of alert-receiving vehicles CA1 to CA3. The server 200 is connected to and communitive to the alert-receiving vehicles CA1 to CA3. The dangerous driving vehicle alert system 1000 issues alert relating to a potential dangerous driving vehicle to the alert-receiving vehicles CA1 to CA3. Other vehicles than the alert-receiving vehicles CA1 to CA3 are also shown in FIG. 1. These other vehicles are shown by averaged safe (normal) vehicles CN1 to CN3, and potential dangerous driving vehicles CD1 to CD2. It is noted that dangerous driving vehicles only refer to vehicles that have the possibility of exhibiting dangerous behaviors but do not mean vehicles that are actually dangerous. Data of images of other vehicles that are captured by the alert-receiving vehicles CA1 to CA3 are transmitted to the server 200 in the dangerous driving vehicle alert system 1000. The server 200 analyzes the image data collected to extract dangerous driving vehicles, which possibly exhibit dangerous behaviors, and transmit information relating to the dangerous driving vehicles to the alert-receiving vehicles CA1 to CA3. When receiving the information, the alert-receiving vehicles CA1 to CA3 can watch the dangerous driving vehicles or choose alternative path to avoid the dangerous driving vehicles, or take other measures against the dangerous driving vehicles if the dangerous driving vehicles run around the alert-receiving vehicles CA1 to CA3.

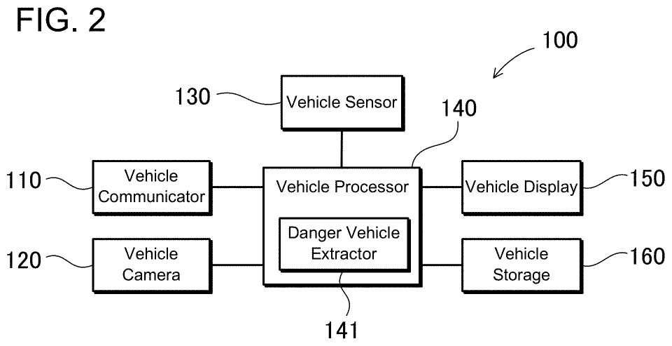

FIG. 2 is a block diagram of each alert receiving vehicle. The illustrated alert receiving vehicle includes a vehicle-side communicator 110, a vehicle-mounted camera 120, a vehicle-side sensor 130, a vehicle-side processor 140, a vehicle-side display 150, and a vehicle-side storage 160. The vehicle-side processor 140 serves as a dangerous driving vehicle alert device 100, which receives information relating to potential dangerous driving vehicles from the server 200, and indicates the information on the vehicle-side display 150. The dangerous driving vehicle alert device 100 can be constructed of an onboard device that is integrally formed with a component other than vehicle-side processor 140, such as the vehicle-side display 150. Alternatively, a dangerous driving vehicle alert program can be installed on smart terminals, such as smartphones and tablets, that belong to motorists and each smart terminal is connected to the vehicle-mounted camera 120, the drive recorder, and the like, if necessary, so that it functions as the dangerous driving vehicle alert device 100.

### (Vehicle-Mounted Camera 120)

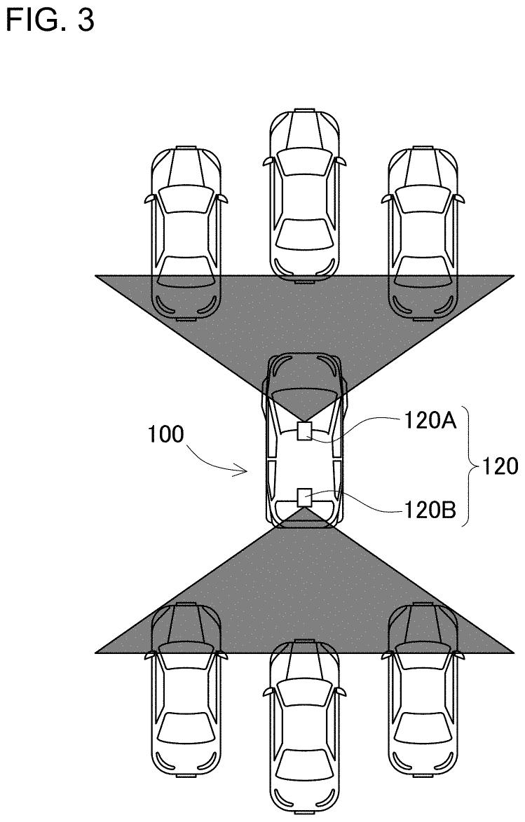

The vehicle-mounted cameras 120 are mounted to the alert receiving vehicles to capture images corresponding to their fields of view (FOVs), which are viewed from the alert receiving vehicles. The vehicle-mounted camera 120 is arranged at a place and an angle to view (or capture images of) one or more vehicles that are located around each alert receiving vehicle (vehicle to be alerted). For example, the vehicle-mounted camera is fastened to an upper part of a windshield or to a dashboard in front of driver's seat of the alert receiving vehicle. Two or more vehicle-mounted cameras 120 can be provided to one alert receiving vehicle. An exemplary alert receiving vehicle shown in a plan view of FIG. 3 includes front and rear vehicle-mounted cameras 120A and 120B, which can view vehicles to be analyzed (analyzed vehicles) on the front and rear side of the alert receiving vehicle, respectively. Because the alert receiving vehicle that includes the front and rear vehicle-mounted cameras 120 can capture images of a plurality of vehicles in forward and rearward areas of the alert receiving vehicle, data of such vehicles can be efficiently collected. The front or rear vehicle-mounted camera 120A or 120B can include two or more cameras. For example, the front vehicle-mounted camera 120A can include two cameras of front right and front left cameras, which face front rightward and front leftward, respectively. Also, the front vehicle-mounted camera 120A can additionally include a front middle camera, which is arranged between the front right and front left cameras (total three cameras). Similarly, the rear vehicle-mounted camera 1208 can include two or more cameras. Also, the vehicle-mounted camera 120 can include right and left cameras, which views sideways areas of the alert receiving vehicle.

The alert receiving vehicle that additionally includes right and left cameras can capture images of vehicles in the sideways areas to be included to the data of images. A radar or LIDAR (light detection and ranging), which includes sensors (e.g., infrared sensors) used together, can be used in addition to the vehicle-mounted camera 120. Intelligent Transport Systems (ITS), which uses sensors arranged on roads, can be used together with the vehicle-mounted camera 120.

The data of images that are captured by the vehicle-mounted camera 120 are preferably not still images but moving images. Moving images help to analyze patterns of driving behavior of vehicles that run near the vehicle to be alerted. When a first trigger, which defines predetermined first timing, is provided, moving images are recorded in a predetermined time period from the first trigger.

### (Vehicle-Side Storage 160)

The data of images recorded is saved in the vehicle-side storage 160. The vehicle-side storage 160 saves the data of images (image capture data) that are captured by the vehicle-mounted camera 120. A hard disk or a semiconductor memory can be suitably use as the vehicle-side storage 160. Alternatively, a drive recorder, which includes both the vehicle-mounted camera 120 and the vehicle-side storage 160, can be used.

The image capture data can be temporarily stored in a buffer memory. In the case in which a high-speed buffer memory is used, the image capture data can be efficiently saved. The data, which is temporarily stored in the buffer memory, will be deleted after written into the vehicle-side storage 160. Alternatively, the data can be overwritten with new image capture data. Also, image capture data that is stored in the vehicle-side storage 160 can be overwritten in order of oldest to newest. As a result, the vehicle-side storage 160, which has a limited capacity, can save the latest image capture data. Consequently, image capture data storage can be efficient.

The image capture data is preferably compressed when saved or transmitted. When compressed, even a large amount of data can be easily handled. In particular, moving image data will large. In the case in which such a large amount of moving image data is compressed, time for saving or transmitting the data can be reduced, and load of processing the data can be light. Known suitable algorithms can be used to compress such data. For example, H.264, H.265, MPEG-4, or the like can be used. Also, a standard format, such as MP4, MPG, WebM, and ts, can be used as a format of the image capture data.

### (Vehicle-Side Sensor 130)

The vehicle-side sensor 130 detects a position of the alert receiving vehicle. The vehicle-side sensor 130 can include one or a combination of a GPS sensor, a gyro sensor, and an accelerometer. A sensor of a smart terminal, such as a smartphone or tablet, can be used as the vehicle-side sensor 130. For example, a smartphone that belong to a motorist of the alert receiving vehicle is connected via standard telecommunications, such as Bluetooth (trade name) and WiFi, so that positional information of the alert receiving vehicle can be obtained by using a sensor, such as GPS, that is included in smart terminal. In the case in which such a sensor of a smart terminal is used as the vehicle-side sensor 130, an additional sensor that is installed on the alert receiving vehicle is not required. In this case, the cost of the sensor can be reduced.

### (Vehicle-Side Communicator 110)

The vehicle-side communicator 110 transmits/receives data to/from a server-side communicator 210 discussed later of the server 200. Existing public communication networks, such as 3G, 4G (LTE), and 5G, can be used for data transmission. Alternatively, dedicated base stations can be distributed so that the vehicle-side communicators 110 transmit/receive data via the base stations to/from the server 200. Also, standard wireless communications, such as WiFi, Bluetooth including BLE (Bluetooth Low Energy), and Zigbee (trade names), can be used.

A smart terminal, such as a smartphone or a tablet, which has communication functions, can be used as the vehicle-side communicator 110. For example, a smartphone that belong to a motorist of the alert receiving vehicle is connected via standard telecommunications, such as Bluetooth (trade name) and WiFi, so that the vehicle-side communicator 110 transmits/receives data to/from the server 200 by using the communication functions of the smart terminal. In the case in which such communication functions of a smart terminal is used as the vehicle-side communicator 110, additional communication functions are not required for the alert receiving vehicle. In this case, the cost of the communication functions can be reduced.

The vehicle-side communicator 110 transmits sent-to-server data to the server 200 at predetermined first timing. The sent-to-server data includes the data of images, which is saved in the vehicle-side storage 160, and positional information that is detected by the vehicle-side sensor 130 and represents image capture positions at which the images are captured. Also, the vehicle-side communicator 110 receives sent-to-vehicle data from the server 200.

### (Sent-to-Server Data)

The sent-to-server data can include additional information relating to date and time of image capture, a speed of the alert receiving vehicle at image capture, weather conditions at the date, and the like, in addition to the aforementioned image capture data and positional information. The positional information can be used to specify a position where a dangerous driving vehicle exhibits a dangerous behavior or positions of the dangerous driving vehicle around the time of such a dangerous behavior. The date and time of image capture can be used to assign a higher weight to newer information and lower weight to older information. As a result, if a vehicle has exhibited dangerous behaviors before but does not exhibit such dangerous behaviors for a long time from its last dangerous behavior, the vehicle can be removed from a list of potential dangerous driving vehicles. Consequently, information relating to potential dangerous driving vehicles can be reliable. Also, the speed of the alert receiving vehicle can be used to calculate actual speeds (absolute speeds) of other vehicles that are included in the image capture data in accordance with comparisons between speeds of the alert receiving vehicle and other vehicles. Also, the weather conditions at the date can be used to assign a weight depending on weather conditions. Vehicles can unintentionally exhibit dangerous behaviors under hard weather conditions, such as rain, snow, and strong winds, which can make road surface or traffic conditions bad. This weather-dependent weighting can be considered useful for fair evaluation. In the case in which the sent-to-server data is constructed as multimodal data that includes information detected by a plurality of detectors in addition to the image capture data, such additional information can be useful to classify each vehicle to be analyzed into dangerous driving levels.

### (Vehicle-Side Display 150)

The vehicle-side display 150 can display a map, information, and the like. A monitor or display, such as organic electroluminescent display and liquid crystal display, can be used as the vehicle-side display 150. The vehicle-side display 150 can show a road map of an area around the alert receiving vehicle. Similar to typical automotive navigation systems, the vehicle-side display 150 shows a maps, such as a road map, and indicate a position of the alert receiving vehicle, which is detected by the vehicle-side sensor 130, on the map.

### (Vehicle-Side Processor 140)

The vehicle-side processor 140 is connected to and controls the vehicle-side communicator 110, the vehicle-mounted camera 120, the vehicle-side sensor 130, the vehicle-side display 150, and the vehicle-side storage 160, as shown in FIG. 2. For example, the vehicle-side processor 140 directs the vehicle-mounted camera 120 to capture images of other vehicles including their vehicle registration plates, and the vehicle-side communicator 110 to transmit data of the images captured to the server 200. When the vehicle-side communicator 110 receives the sent-to-vehicle data discussed detail later from the server 200, the vehicle-side processor 140 indicates a position of a dangerous driving vehicle on the map on the vehicle-side display 150.

The vehicle-side processor can acquire information relating to a speed and an engine RPM of, a distance traveled by the alert receiving vehicle, and the like. For example, the vehicle-side processor is connected to an ECU, which controls an internal-combustion engine or driving electric motor, or the like, and acquires information relating to the internal-combustion engine or driving electric motor. Actual speeds of other vehicles that are included in images captured by the vehicle-mounted camera 120 can be calculated in accordance with a speed of the alert receiving vehicle that is acquired as discussed above. As a result, other vehicles can be more properly analyzed.

The vehicle-side processor 140 can be constructed of a processor or microcomputer, such as a CPU, MPU, GPU or TPU, as well as, FPGA, ASIC or LSI, or a chip sets, such as SoC or MCU.

### (Dangerous Driving Vehicle Extractor 141)

The vehicle-side processor 140 can also serve as a function of a dangerous driving vehicle extractor 141. The dangerous driving vehicle extractor 141 analyzes patterns of driving behavior of vehicles to be analyzed that are included in the data of images based on the data of images to extract a dangerous driving vehicle that exhibits a predetermined dangerous behavior. If detecting patterns of driving behavior corresponding to a dangerous behavior, the alert receiving vehicle transmits the image capture data to the server 200. The alert receiving vehicle that includes the dangerous driving vehicle extractor transmits to the server 200 not all the patterns of driving behavior of vehicles to be analyzed but only image capture data that includes the dangerous behavior. The server 200 can efficiently find dangerous driving vehicles and inform alert receiving vehicles to be alerted of the dangerous driving vehicles. (First Timing)

The alert receiving vehicles transmit sent-to-server data to the server 200 at the first timing. The first timing is the time when the dangerous driving vehicle extractor 141 extracts patterns of driving behavior corresponding to a dangerous behavior. In the case of the first timing as defined above, the first trigger, which defines the first timing, is the time of occurrence of a dangerous behavior. The alert receiving vehicles transmit image capture data and the like to the server 200 only when extracting patterns of driving behavior corresponding to a dangerous behavior as discussed above. In other words, image capture data of averaged safe vehicles is not transmitted to the server. As a result, unnecessary data processing can be reduced. Consequently, dangerous driving vehicle alert system can efficiently operate.

The dangerous driving vehicle alert device can be configured to allow users to specify their desired timing at which the dangerous driving vehicle alert device transmits the sent-to-server data such as image capture data to the server. This dangerous driving vehicle alert device can transmit information relating to a vehicle that is felt dangerous by a motorist of the dangerous driving vehicle alert device. Such information also can provide efficient dangerous driving vehicle alert system operation. Also, the dangerous driving vehicle alert device can be configured to allow users to activate transmission of image capture data in addition to the extraction by the dangerous driving vehicle extractor 141 of patterns of driving behavior corresponding to a predetermined dangerous behavior.

Alternatively, a predetermined cycle can be used to define the first timing at which the alert receiving vehicles transmit sent-to-server data to the server. In the case in which the first timing is a predetermined cycle, information relating to other vehicles can be collected without conscious of users. As a result, load on motorists can be light. Consequently, time and efforts are not required for the motorists. In addition, extraction of dangerous behaviors is independent on awareness of motorists. Because the alert receiving vehicles do not determine whether to categorize each vehicle to be analyzed into a dangerous driving vehicle, load on the alert receiving vehicles can be light. Contrary to this, because image capture data periodically transmitted, load on the dangerous driving vehicle alert system will be heavy.

### (Server 200)

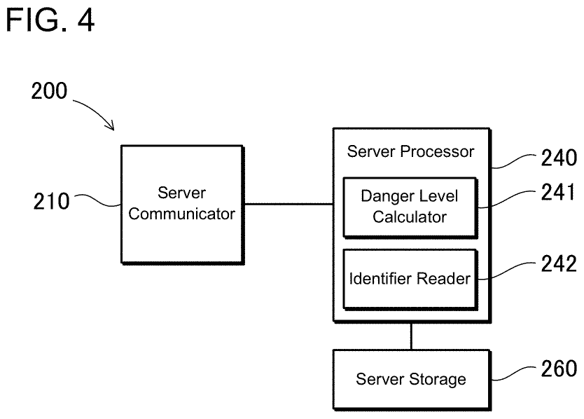

Exemplary components of the server 200 are now described with reference to a block diagram of FIG. 4. The illustrated server 200 includes the server-side communicator 210, a server-side processor 240, and a server-side storage 260.

### (Server-Side Communicator 210)

The server-side communicator 210 transmits/receives data to/from vehicle-side communicators 110, which are included in the alert receiving vehicles. The server-side communicator 210 is a communication module that can transmit/receive data. Known suitable standard wireless communications, such as WiFi and Bluetooth, can be used for the server-side communicator 210.

### (Server-Side Storage 260)

The server-side storage 260 stores vehicle information relating to dangerous driving vehicles, and patterns of driving behavior to be used to categorization to dangerous driving. The patterns of driving behavior are previously stored in a dangerous driving pattern database. The server-side storage 260 includes the dangerous driving pattern database. The server-side storage 260 is constructed of storage devices, such as hard disks and semiconductor memories.

### (Server-Side Processor 240)

The server-side processor 240 is connected to the server-side and communicator and storage 210 and 260, and controls operations of the server-side and communicator and storage 210 and 260. The server-side processor 240 includes a dangerous driving level calculator 241. The server-side processor 240 can be also constructed of a processor or microcomputer, such as a CPU, MPU, GPU or TPU, as well as, FPGA, ASIC or LSI, or a chip sets, such as SoC or MCU.

### (Dangerous Driving Level Calculator 241)

The server-side processor 240 can serve as a function of the dangerous driving level calculator 241. The server-side communicator 210 receives the sent-to-server data including image capture data and positional information, which are transmitted through the vehicle-side communicators 110 from the alert receiving vehicles. The positional information relates to positions at which the image capture data is acquired. The dangerous driving level calculator 241 analyzes patterns of driving behavior of vehicles to be analyzed that are included in the image capture data to calculate dangerous driving levels of the vehicles analyzed so that the dangerous driving levels calculated of the vehicles to be analyzed are compared with a predetermined value. Each vehicle to be analyzed categorized into a dangerous driving vehicle if its dangerous driving level is higher than the predetermined value.

The server-side processor 240 transmits the positional information and the dangerous driving level of the dangerous driving vehicle as the sent-to-vehicle data to the alert receiving vehicles. The alert receiving vehicles can indicate the dangerous driving level of the dangerous driving vehicle on the road maps on their vehicle-side displays 150 based on the position of the dangerous driving vehicle as discussed above.

This indication of the dangerous driving level of the dangerous driving vehicle can inform motorists who drive the alert receiving vehicles, which are used in the dangerous driving vehicle display system, of existence of a potential dangerous driving vehicle, which can cause accidents, and its position. Motorists cannot know such a dangerous driving vehicle in conventional systems unless they directly see unsafe behaviors of the dangerous driving vehicle. For this reason, before seeing unsafe behaviors, motorists avoid neither approaching dangerous driving vehicles nor choosing an alternative path. Contrary to this, motorists who use the aforementioned system can know existence of a potential dangerous driving vehicle even when not seeing the vehicle. As a result, they can avoid approaching the vehicle. Consequently, they can safely drive their vehicles. Therefore, the aforementioned indication of the dangerous driving level of the dangerous driving vehicle can reduce or prevent the risk of incidents and accidents caused by potential dangerous driving vehicles.

### (Vehicle Registration Plate Reader 242)

The server-side processor 240 can includes a vehicle registration plate reader 242. The vehicle registration plate reader 242 shown in FIG. 4 extracts a vehicle registration plate of a dangerous driving vehicle that is included in image capture data, and reads its identifier from the vehicle registration plate to obtain vehicle identifier information. The server that includes the vehicle registration plate reader 242 transmits sent-to-vehicle data that includes the vehicle identifier information, which is obtained by the vehicle registration plate reader 242, to the alert receiving vehicles. The alert receiving vehicles can indicate the vehicle identifier information, which is included in the sent-to-vehicle data, on their vehicle-side displays 150 in response to reception of the sent-to-vehicle data. Consequently, motorists who drive the alert receiving vehicles can watch the dangerous driving vehicle, which is specified by the vehicle identifier information.

### (Driving Behavior Patterns)

The alert receiving vehicle captures patterns of driving behavior of vehicles to be analyzed by using the vehicle-mounted camera 120, and transmits the image capture data through the vehicle-side communicator 110 to the server 200. The server 200 analyzes the image capture data that are transmitted from the alert receiving vehicles and calculate scores corresponding to dangerous driving degrees of the vehicles to be analyzed to determine their dangerous driving levels. The server 200 categorizes each vehicle to be analyzed into a dangerous driving vehicle if its dangerous driving level is higher than a predetermined value. The server 200 transmits sent-to-vehicle data that includes information relating to the dangerous driving vehicle to the alert receiving vehicles. The alert receiving vehicles indicate the dangerous driving level and a position of the dangerous driving vehicle on the road maps on their vehicle-side displays 150 based the sent-to-vehicle data.

### (Dangerous Driving Degree)

Scores corresponding to dangerous driving degrees of vehicles to be analyzed are used to determine whether to categorize patterns of driving behavior of the vehicles to be analyzed into patterns of driving behavior corresponding to any of predetermined dangerous behaviors. Example criteria to be considered in the categorization of patterns of driving behavior of each vehicle to be analyzed (analyzed vehicle) that are included in data of images that are captured by alert receiving vehicles (alerted vehicles) can be provided by whether the analyzed vehicle suddenly brakes, whether abrupt steering input is applied to the analyzed vehicle (abrupt cornering), whether a distance between each alerted vehicle and the analyzed vehicle falls within a safety range (whether the analyzed vehicle violates a safety distance between each alerted vehicle and the analyzed vehicle), how often the analyzed vehicle makes a lane change, whether the analyzed vehicle honks its horn, whether the analyzed vehicle uses headlight flashing (passing light), whether the analyzed vehicle repeatedly drifts out of its lane, whether the analyzed vehicle goes the wrong way, whether the analyzed vehicle runs a red light, and the like. Scores are previously assigned to the criteria depending on their danger degrees. The patterns of driving behavior are previously stored in the dangerous driving pattern database of the server 200. If patterns of driving behavior corresponding to predetermined dangerous behaviors are detected from images of an alerted vehicle, scores that are assigned to the patterns of driving behavior are added to a current total score of the alerted vehicle. Vehicles to be analyzed can be distinguished from each other based on their vehicle registration plate as well as their colors and vehicle types, or a combination of them.

Every when patterns of driving behavior corresponding to predetermined dangerous behaviors are detected from each alerted vehicle, scores corresponding to degrees of dangerous driving are added to a current total score of the alerted vehicle. If an accumulated score of dangerous driving degrees of an alerted vehicle becomes greater than a predetermined value, the alerted vehicle is determined as a dangerous driving vehicle by the dangerous driving level calculator 241. In this embodiment, because examples of dangerous behaviors are previously defined and are given weights (different scores) depending on danger degrees of the dangerous behaviors to classify a dangerous driving vehicle to dangerous driving levels, objective categorization can be provided.

Known suitable image processing, such as pattern recognition, can be used to detect patterns of driving behavior. Deep learning which uses AI can be used for calculation of scores of dangerous driving degrees and classification to dangerous driving levels in the dangerous driving level calculator 241.

If a vehicle has exhibited dangerous behaviors before but does not exhibit additional dangerous behaviors for a predetermined time period from its last dangerous behavior, its total score (dangerousness evaluation), which is obtained by accumulating scores corresponding to its dangerous behaviors, can be reduced. Such dangerousness reevaluation can relatively reduce weights on emergency or sporadic dangerous behaviors. As a result, more proper evaluation can be provided.

### Second Embodiment

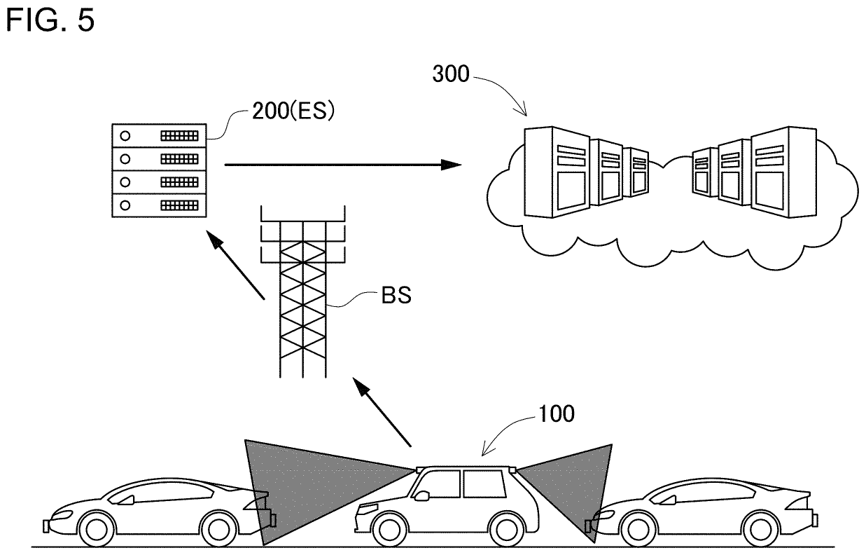

A part or the entire of processing on the server can be performed by another apparatus. For example, in a second embodiment, a plurality of the aforementioned servers are provided to function as edge servers so that a cloud server, which is separately provided, can manage the edge servers. In a second embodiment, a land or map is divided into a number of areas so that each area includes a server 200 (edge server ES). The edge servers ES are connected to a cloud server 300. A dangerous driving vehicle alert system according to the second embodiment is now described with reference to FIG. 5.

### (Cloud Server 300)

The cloud server 300 is connected to the edge servers ES to transmit data between the cloud server and the edge servers ES. The sent-to-vehicle data and the sent-to-server data, which are transmitted to and from the edge server ES, are collected by and stored in the cloud server 300. In this embodiment, edge computing is realized by the servers ES, which are distributed in areas and cover operations in their areas, and the cloud server 300, which entirely manages data in the system. As a result, delays can be reduced. Also, because operations are distributed, the operations can be efficiently performed. In addition, because data or operations can be backed up, the system can reliably operate.

### (Edge Server ES)

In the system shown in FIG. 5, the edge servers ES receive image capture data from alert receiving vehicles via base stations BS. The dangerous driving level calculators 241 of the edge servers ES analyze compression video data, which is the image capture data, by using AI processing, to calculate a dangerous driving score of a dangerous driving vehicle, and determines its dangerous driving level. The dangerous driving level calculator 241 has a pattern file that is used in dangerous driving determination. The dangerous driving level calculator 241 analyzes image capture data that is transmitted from the alert receiving vehicles by using AI, and learns new driving dangerous behaviors and the like to update its pattern recognition.

If the video data does not include any dangerous driving vehicle and is not necessarily analyzed, it is transmitted without analysis to and stored in the cloud server 300.

The cloud server 300 stores and saves the video data, which is transmitted from the edge servers ES, associated with unique ID or vehicle-identifier information. The saved video image data can be used later if a user requires it or as reasonable grounds in a car accident lawsuit and the like.

Motorists can receive service provided by the aforementioned dangerous driving vehicle display system, which informs them of potential dangerous driving vehicles, by purchasing the dangerous driving vehicle alert device 100 and attaching it to their vehicles, or installing the dangerous driving vehicle alert program on their smart terminals, such as smartphones or tablets, that belongs to them. Alternatively, in an alternative system, motorists can receive the service by using an existing drive recorder, which records image capture data, and their smart terminals. In this system, the smart terminals transmit the image capture data to the server 200, and receive information relating to a position, a dangerous driving level, and the like, of a dangerous driving vehicle that are obtained based on analysis of the image capture data by the server 200 to indicate the information on display screens of the smart terminals or automotive navigation systems of their vehicles.

### (Exemplary System Configuration)

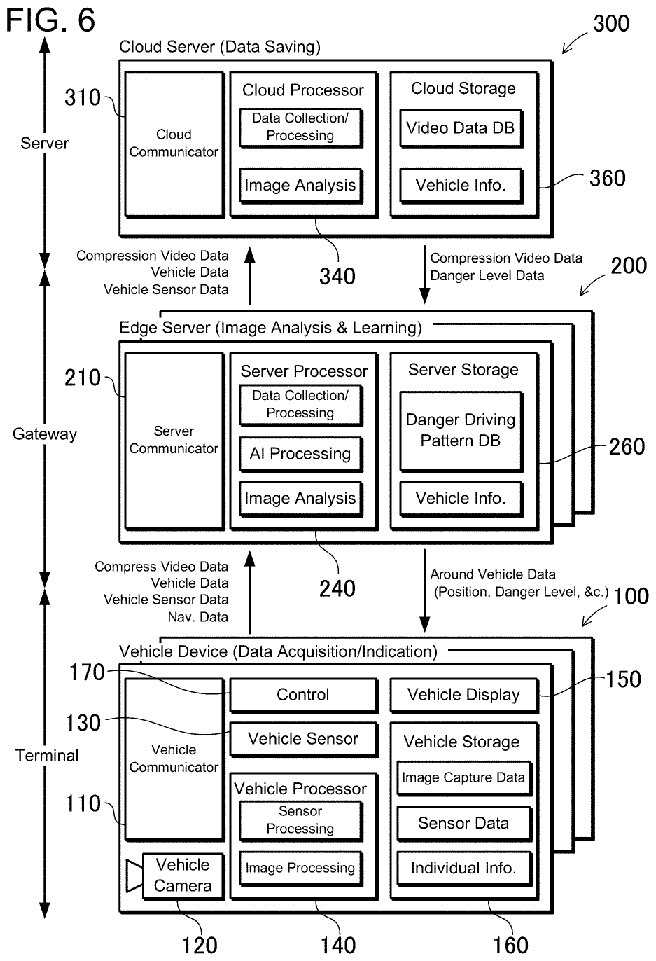

FIG. 6 is a block diagram showing an exemplary system configuration of the dangerous driving vehicle alert system. This illustrated dangerous driving vehicle alert system includes the dangerous driving vehicle alert devices 100, which are placed in the alert receiving vehicles, the servers 200 (edge servers ES), and the cloud server 300. In this configuration, the dangerous driving vehicle alert devices 100 serve as terminals or clients, the edge servers ES serve as gateways, and the cloud server 300 serves as a server. The following description will describe these components. Components that have the same or similar functions of the components of the foregoing embodiment are attached with the same reference signs as the foregoing embodiment, and their description is omitted.

The dangerous driving vehicle alert device 100 includes the vehicle-side communicator 110, the vehicle-mounted camera 120, a control 170, the vehicle-side sensor 130, the vehicle-side processor 140, the vehicle-side display 150, and the vehicle-side storage 160. The control 170 is a trigger switch that is pressed by a motorist when the motorist sees a dangerous behavior of a vehicle to activate the camera to capture images of the vehicle.

This dangerous driving vehicle alert device 100 can be constructed of a vehicle-mounted device, which is attached to the alert receiving vehicle as discussed above, or a smart terminal, such as a smartphone, that belongs to the motorist and is installed with the dangerous driving vehicle alert program. In the following description, such a smart terminal will be not distinguished from the vehicle-mounted device, and both will be referred to as a vehicle-mounted device. Unique ID numbers are assigned to the vehicle-mounted devices (i.e., alert receiving vehicles) to identify the vehicle-mounted devices. For example, vehicle-mounted device IDs assigned to pieces of the vehicle-mounted device hardware and application IDs assigned to the dangerous driving vehicle alert programs can be used as the unique ID numbers. In the following description, such an application ID will be not distinguished from the vehicle-mounted device ID, and both will be referred to as a vehicle-mounted device ID.

The vehicle-side storage 160 has an image-data storage area that stores data of images captured by the vehicle-mounted camera 120, and a sensor data storage area that store sensor data such as positional information acquired by the vehicle-side sensor 130. The vehicle-side storage 160 additionally has an individual information storage area that stores individual information including a vehicle-mounted device ID, information relating to dangerous driving vehicles, and the like. Examples of the information relating to dangerous driving vehicles can be provided by vehicle-identifier information, vehicle types, colors, dangerous driving levels, and the like, of the dangerous driving vehicles.

Data of images that are captured by the vehicle-mounted camera 120 is saved in the image-data storage area of the vehicle-side storage 160 of the vehicle-mounted device. Sensor data such as positional information, etc., that are acquired by the vehicle-side sensor 130 is saved in the sensor data storage area of the vehicle-side storage 160. The vehicle-side processor 140 processes the sensor data (sensor processing) and the image data (image processing). Subsequently, sent-to-server data is produced and is transmitted to the edge server ES through the vehicle-side communicator 110. The sent-to-server data includes compressed moving image data as image data, vehicle data, vehicle sensor data, navigation data, and the like. For example, processing by the vehicle-side processor 140 includes storage of positional information acquired by GPS, vehicle G, acceleration, steering angle, steering speed, and the like, which are used to detect motion of the vehicle, together with system time in synchronization with time stamps of video data to calculate a dangerous driving degree (score) when an alert-receiving vehicle exhibits a dangerous behavior The vehicle-side processor 140 can serve as a weight assigner for such weighting.

### (Edge Server ES)

Each edge server 200 includes the server-side communicator 210, a server-side processor 240, and a server-side storage 260. The server-side processor 240 performs data collection, image analysis, and AI processing.

In the data collection, image capture data from alert receiving vehicles is collected. In the image analysis, driving patterns and vehicle registration plates of vehicles to be analyzed are extracted from the image capture data collected. In the AI processing, dangerous behaviors are analyzed and are given danger degrees.

The server-side storage 260 has a dangerous driving pattern database and a vehicle information storage area. The dangerous driving pattern database stores examples of dangerous driving patterns that are determined as dangerous driving. The vehicle information storage area stores vehicle information relating to the dangerous driving vehicles.

Similar to the aforementioned server 200 shown in FIG. 4, the edge servers ES transmit/receive data to/from the vehicle-side communicators 110 of the alert receiving vehicles. More specifically, the server-side communicators 210 receive sent-to-server data from the vehicle-side communicators 110 at first timing and transmit sent-to-vehicle data to the vehicle-side communicators 110 at the second timing. The sent-to-vehicle data includes data relating to vehicles around each alert receiving vehicle (positions, dangerous driving levels of dangerous driving vehicle, etc.).

### (Second Timing)

The server-side communicators 210 transmit the sent-to-vehicle data at the second timing. The second timing is the time when the dangerous driving level calculator 241 determines that a dangerous driving level of a dangerous driving vehicle becomes greater than a predetermined value. Alternatively, the second timing can be a predetermined cycle. In this case, dangerous driving vehicle alert device can periodically update dangerous driving levels of dangerous driving vehicles.

### (Cloud Server 300)

The cloud server 300 includes a cloud-side communicator 310, a cloud-side processor 340, and a cloud-side storage 360. The cloud-side communicator 310 transmits/receives data to/from the server-side communicators 210 of the edge servers ES.

The cloud-side processor 340 is connected to the cloud-side communicator and storage 310 and 360, and controls the cloud-side communicator and storage 310 and 360. This cloud-side processor 340 collects compression video data, vehicle data, vehicle sensor data, and the like by controlling the cloud-side communicator 310, and saves them into the cloud-side storage 360. As a result, information such as image capture data that are captured by the alert receiving vehicles is collected through the edge server ES and stored in the cloud server 300. The cloud-side processor 340 performs data collection, image analysis of the data collected, and the like. In addition, the cloud-side processor 340 transmits compression video data and dangerous driving level data to the edge servers ES.

Also, the cloud-side storage 360 is constructed of hard disks, semiconductor memories, and the like. The cloud-side storage 360 includes a video data base and a vehicle information storage area. The video data base saves data of images that are captured by the alert receiving vehicles and collected via the edge servers ES. The vehicle information storage area stores vehicle-mounted device IDs of the alert receiving vehicles, vehicle-identifier information on dangerous driving vehicles, danger degrees, dangerous driving level, and the like.

### (Cloud Server Data Table)

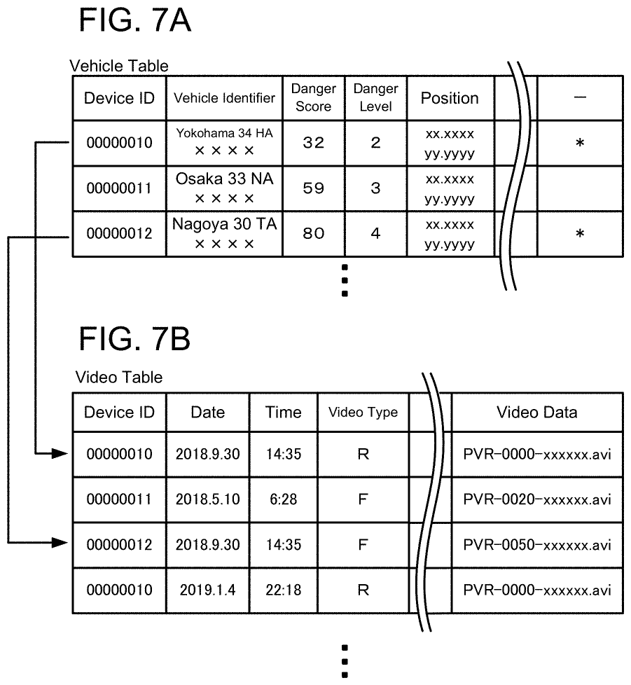

Exemplary data tables that are included in the cloud-side storage 360 of the cloud server 300 are shown in FIGS. 7A and 7B. More specifically, vehicle and image tables are shown in FIGS. 7A and 7B, respectively. The vehicle table stores information such as vehicle-mounted device ID, vehicle identifier, current danger score, and the dangerous driving level of each alert-receiving vehicle. The image table stores information such as date and time of image capture, vehicle sensor data, video image data, and the like. The vehicle table and the image tables are linked to each other through the vehicle-mounted device IDs so that video image data is accessible through the vehicle-mounted device IDs.

Although the edge servers ES have been illustratively described to determine dangerous driving levels in this embodiment, the present disclosure is not limited to this. The cloud server 300 can determine dangerous driving levels. In the case in which the cloud server 300 collectively determines dangerous driving levels, centralized machine resources will be provided. Alternatively, alert receiving vehicles can determine dangerous driving levels. The alert receiving vehicles that determine dangerous driving levels can successively determine dangerous driving levels, As a result, time delay relating to transmission rates will not affect determination of dangerous driving levels. Consequently, even if data transmission is partially interrupted (for example, even in a tunnel or an intermontane area), dangerous driving levels can be continuously determined. But the alert-receiving-vehicles necessarily have high processing performance for determination of dangerous driving levels.

### (Operation Flowchart)

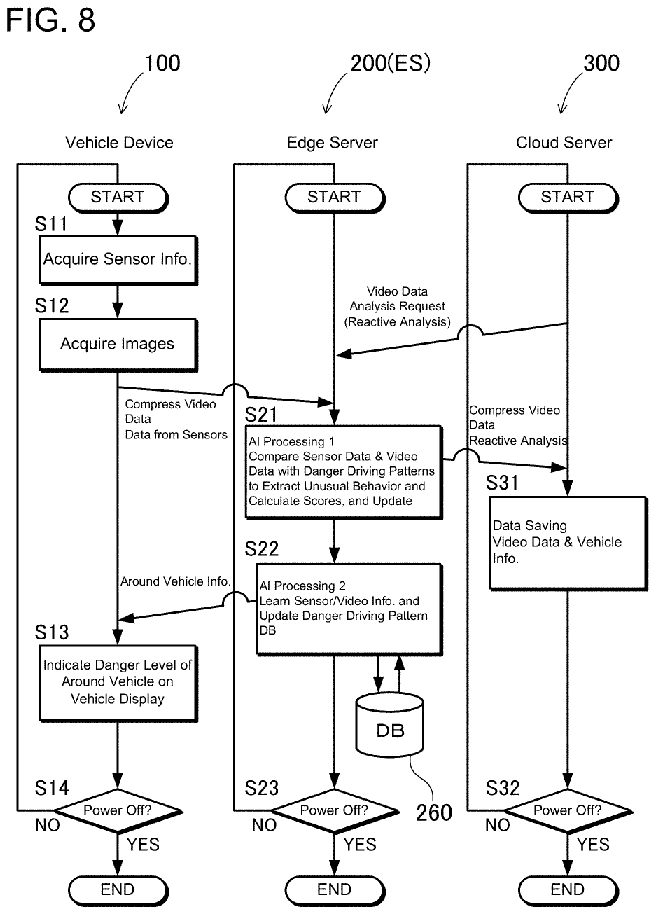

FIG. 8 is a flowchart showing operations of the vehicle-mounted device, the edge server ES, and the cloud server 300. The vehicle-mounted device first acquires sensor information in Step S11. Examples of the sensor information can be provided by accelerator information such as an ON/OFF status and an angle of an accelerator pedal, brake information such as an ON/OFF status and an angle of a brake pedal, sensor outputs from a G sensor, a gyro sensor, an acceleration sensor, etc., a speed of an alert receiving vehicle, a signal from a trigger switch of the control 170, and the like. Subsequently, image capture data is obtained in Step S12. In this step, moving images are captured by the vehicle-mounted cameras 120, which are fastened onto front and rear parts of the alert receiving vehicle. The moving images obtained are compressed and transmitted together with sensor information as sent-to-server data to the edge server ES.

AI processing 1 is performed in response to the sent-to-server data transmission by the edge server ES, in Step S21. In this step, the sensor information and the image capture data are compared with dangerous driving patterns to extract unusual driving behaviors and calculate scores corresponding to the unusual driving behaviors. Correspondingly, dangerous driving scores are updated in accordance with the scores calculated. Subsequently, dangerous driving pattern database is updated as AI processing 2 by learning the sensor information and image information received in Step S22.

The edge server ES transmits sent-to-vehicle data to the alert receiving vehicle. The sent-to-vehicle data includes information relating to vehicles around the alert receiving vehicle. The alert receiving vehicle indicates dangerous driving levels of the vehicles around the alert receiving vehicle on the vehicle-side display 150 based the sent-to-vehicle data in Step S13. Subsequently, it is determined whether the alert receiving vehicle is powered off in Step S14. If not, the procedure returns to Step S11 and repeats the routine. Similarly, following Step S22, it is determined whether the alert receiving vehicle is powered off in Step S23 in the edge server ES.

If not, the procedure returns to Step S21 and repeats the routine.

The cloud server 300 issues a request for video data analysis prior to the AI processing 1 (Step S21) in the edge server ES. The video data analysis can be considered as reactive analysis. Subsequently, the cloud server 300 receives compression video data and vehicle information obtained in the AI processing 1 (Step S21) of the edge server ES that are transmitted from the edge server ES, and save them in Step S31. In this step, the video image data and vehicle information are saved into the cloud-side storage 360. Subsequently, it is determined whether the alert receiving vehicle is powered off in Step S32. If not, the procedure returns to Step S31 and repeats the routine.

As a result, information relating to dangerous driving vehicles can be grasped by the data transmission between the vehicle-mounted device, the edge server ES, and the cloud server. Consequently, the alert receiving vehicle can indicate the information relating to dangerous driving vehicles.

### (Exemplary Alert for Dangerous Driving Vehicle Approaching)

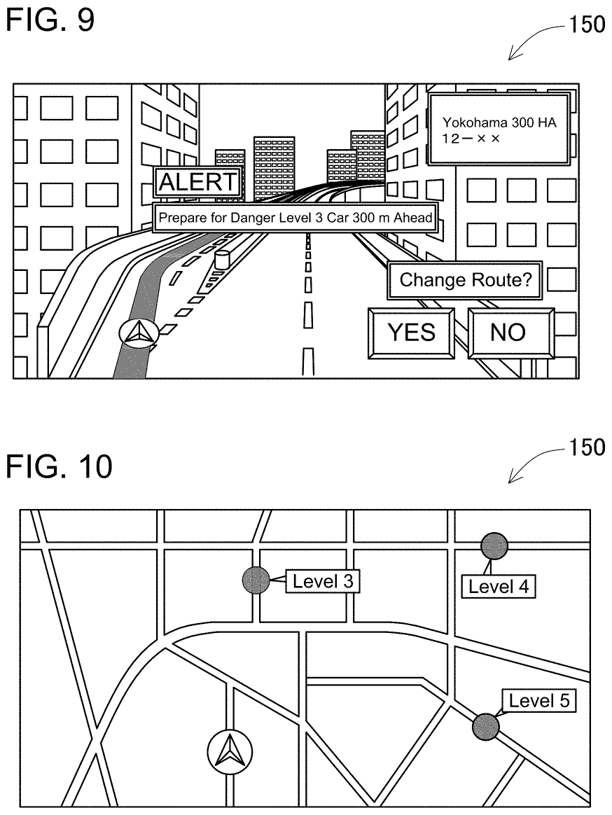

If a dangerous driving vehicle comes into an area within a predetermined distance ahead or behind of a vehicle to be alerted (alert receiving vehicle), alert is issued in the alert receiving vehicle. FIG. 9 is a schematic view showing an exemplary indication of one of dangerous driving vehicles, which is approaching the alert receiving vehicle, on the vehicle-side display 150. Detection of the dangerous driving vehicle is indicated by text, a pop-up menu, and the like shown in FIG. 9. The indication shown in FIG. 9 additionally includes a dangerous driving level, a position, an identifier, and the like of the dangerous driving vehicle. The additional information allows a motorist who drives the alert receiving vehicle to more easily specify the dangerous driving vehicle. The indication can include a color and a car-type of the dangerous driving vehicle, a pattern type of a dangerous driving behavior to which its dangerous driving score is assigned, and the like. Also, voice guidance, beeping sound, image blinking on the screen, vibration of the portable smart terminal, and the like can be used together with the indication. Alternatively, an alternative route can be indicated to avoid the position of the dangerous driving vehicle on the vehicle-side display.

Users can specify setting of dangerous driving vehicle alert, such as minimum alert-issuing dangerous driving level, on the vehicle-mounted device. For example, a user can specify that alert is issued if a dangerous driving level of a dangerous driving vehicle is three or more, and is not issued if the dangerous driving level is greater smaller than three. Another user can specify to issue alert for a dangerous driving vehicle that exhibited any dangerous behavior even once. Another user can specify to issue alert for a dangerous driving vehicle that exhibited a dangerous behavior within a specified period, such as in last one year. Still another user can specify an extent of alert area, such as an area within 5 km around a vehicle to be alerted, to issue alert if a dangerous driving vehicle runs in the area specified.

Alternatively, users can set the alert area in percentage increments to change the alert area to a wider or narrower area.

(Exemplary Indication of Dangerous Driving Vehicle around Alert-Receiving Vehicle)

Dangerous driving vehicles around a vehicle to be alerted (alert receiving vehicle) can be plotted on a map. FIG. 10 is a schematic view showing exemplary indication of dangerous driving vehicles on a map. The position of the alert receiving vehicle, and positions and dangerous driving levels of the dangerous driving vehicles are indicated on the map as shown in FIG. 10. Also in this case, a user can specify a minimum dangerous driving level of dangerous driving vehicles to be indicated on the map. In this case, the minimum dangerous driving level is specified three. Rental cars, sharing cars, company cars, and the like can be excluded from dangerous driving vehicles to be indicated on the map.

The method has been described to issue alert to alert receiving vehicles from server when a dangerous driving vehicle is detected. The present disclosure is not limited to such a method or system that informs alert receiving vehicles of information relating to dangerous driving vehicles but also of various kinds of vehicles. For example, the method or system can inform alert receiving vehicles of information relating to an emergency vehicle such as ambulance, fire engine and police car when the emergency vehicle is detected. Such alert urges motorists who drive the alert receiving vehicles to give a way to the emergency vehicle. As a result, the emergency vehicle can smoothly go along the way given. Also, road traffic safety can be improved even when the emergency vehicle passes other vehicles in case of an emergency. The method or system can inform motorists who drive the alert receiving vehicles of information relating to speed traps or seatbelt checks to improve driver compliance with speed limits or seatbelt wearing. For example, the method or system can inform motorists who drive the alert receiving vehicles of information relating unmarked police cars to improve driver compliance with speed limits. Consequently, the method or system can reduce traffic law violation.

A dangerous driving vehicle alert system, a dangerous driving vehicle alert device and a dangerous driving vehicle alert program, and a computer-readable storage medium or storage device storing the dangerous driving vehicle alert program according to the present disclosure can be suitably used for a system that including terminals that are placed in alert receiving vehicles and have IDs assigned through the dangerous driving vehicle alert program. Also, the present disclosure can be suitably used realized by a service that provides leased terminals to be placed in alert receiving vehicles and having IDs assigned through the dangerous driving vehicle alert program. Alternatively, the present disclosure can be suitably used realized by a service that provides motorists with their own terminals to be placed in alert receiving vehicles. In the service, images are captured by the alert receiving vehicles and transmitted to a server, which analyzes the image data transmitted to distribute information relating to dangerous driving vehicles.

It should be apparent to those with an ordinary skill in the art that while various preferred examples of the invention have been shown and described, it is contemplated that the invention is not limited to the particular examples disclosed. Rather, the disclosed examples are merely illustrative of the inventive concepts and should not be interpreted as limiting the scope of the invention. All suitable modifications and changes falling within the spirit of the invention are intended to be encompassed by the appended claims.

1. A dangerous driving vehicle alert system capable of issuing alert relating to a potential dangerous driving vehicle to alert-receiving vehicles, the system comprising:
a server;
vehicle-side sensors that are included in the alert-receiving vehicles and detect positions of the alert-receiving vehicles;
vehicle-side displays that are included in the alert-receiving vehicles and show road maps of areas around the alert receiving vehicles;
vehicle-mounted cameras that are included in the alert-receiving vehicles and capture images corresponding to FOVs of the vehicle-mounted cameras on the alert-receiving vehicles;
vehicle-side storages that are included in the alert-receiving vehicles and save data of images that are captured by the vehicle-mounted cameras on the alert-receiving vehicles; and
vehicle-side communicators that are included in the alert-receiving vehicles, and can transmit sent-to-server data to a server at predetermined first timing and receive sent-to-vehicle data from the server, the sent-to-server data including the data of images, which is saved in the vehicle-side storages, and positional information that is detected by the vehicle-side sensors of the alert-receiving vehicles and represents image capture positions at which the images are captured,
wherein the server can be connected to the alert receiving vehicles through the vehicle-side communicators of the alert receiving vehicles,
wherein the server comprises
a dangerous driving level calculator that analyzes patterns of driving behavior of vehicles to be analyzed that are included in the data of images based on the sent-to-server data to calculate dangerous driving levels of the vehicles analyzed, and compares the dangerous driving levels calculated of the vehicles to be analyzed with a predetermined value to categorize each vehicle to be analyzed into a dangerous driving vehicle if its dangerous driving level is higher than the predetermined value, and
a server-side communicator that transmits the sent-to-vehicle data to vehicle-side communicators of the alert receiving vehicles at predetermined second timing, and receives the sent-to-server data from the vehicle-side communicators at the first timing, the sent-to-vehicle data including the dangerous driving level of the dangerous driving vehicle, which is calculated by the dangerous driving level calculator, and positional information that represents a position at which an image of the dangerous driving vehicle is captured, and
wherein the dangerous driving level of the dangerous driving vehicle, which is included in the sent-to-server data, can be indicated on the road maps on the vehicle-side displays of the alert receiving vehicles in accordance the position of the dangerous driving vehicle.

2. The dangerous driving vehicle alert system according to claim 1 further comprising dangerous driving vehicle extractors that are included in the alert receiving vehicles and analyze patterns of driving behavior of vehicles to be analyzed that are included in the data of images, which are captured by the vehicle-mounted cameras on the alert-receiving vehicles, based on the data of images to extract a dangerous driving vehicle that exhibits a predetermined dangerous behavior,
wherein the sent-to-server data includes information relating to the dangerous driving vehicle that is extracted by the dangerous driving vehicle extractor, and
wherein the server calculates a dangerous driving level of the dangerous driving vehicle that is extracted by the dangerous driving vehicle extractor by using the dangerous driving level calculator.

3. The dangerous driving vehicle alert system according to claim 2, wherein the first timing is the time of extraction of the dangerous driving vehicle by the dangerous driving vehicle extractor.

4. The dangerous driving vehicle alert system according to claim 2, wherein the first timing is a predetermined cycle.

5. The dangerous driving vehicle alert system according to claim 1,
wherein the server further includes a vehicle registration plate reader that extracts from the dangerous driving vehicle, which is included in the data of images, its vehicle registration plate, and reads its identifier from the vehicle registration plate to obtain vehicle identifier information,
wherein the server transmits sent-to-vehicle data that includes the vehicle identifier information, which is obtained by the vehicle registration plate reader, to the alert receiving vehicles, and
wherein the alert receiving vehicles can indicate the vehicle identifier information, which is included in the sent-to-vehicle data, on their vehicle-side displays.

6. The dangerous driving vehicle alert system according to claim 1, wherein the data of images includes moving images.

7. The dangerous driving vehicle alert system according to claim 6, wherein the data of images that includes moving images is compressed and transmitted between the vehicle-side and server-side communicators.

8. The dangerous driving vehicle alert system according to claim 1, wherein the vehicle-side and server-side communicators transmit data from one to another via a public communication network.

9. The dangerous driving vehicle alert system according to claim 1, wherein the vehicle-mounted camera captures images of a forward, rearward, and/or sideways area(s) of the alert receiving vehicle.

10. The dangerous driving vehicle alert system according to claim 1, wherein the dangerous driving level calculator calculates a dangerous driving level by using artificial intelligence (AI) based on the data of images of the dangerous driving vehicle.

11. The dangerous driving vehicle alert system according to claim 1, wherein the dangerous driving level calculator determines based on patterns of driving behavior of each vehicle to be analyzed at least one of conditions whether it suddenly brakes, whether abrupt steering input is applied to it, whether it violates a safety distance between vehicles, how often it makes a lane change, whether it honks its horn, whether it uses headlight flashing, whether it repeatedly drifts out of its lane, whether it goes the wrong way and whether it runs a red light as at least one parameter, and assigns a weight(s) to the at least one parameter to determine whether to categorize it into a dangerous driving vehicle.

12. The dangerous driving vehicle alert system according to claim 1, wherein the vehicle-side sensor includes at least one of a GPS sensor, a gyro sensor, and an accelerometer.

13. The dangerous driving vehicle alert system according to claim 1,
wherein the vehicle-side sensor is included in a smartphone or tablet that can be placed in the alert receiving vehicle, and
wherein the vehicle-side display is a screen of a map application that can be displayed on a display of the smartphone or tablet, which can be placed in the alert receiving vehicle.

14. The dangerous driving vehicle alert system according to claim 1,
wherein the server is one of a plurality of servers, which are distributed to cover predetermined areas, and
wherein the dangerous driving vehicle alert system further comprises a cloud server that can be connected to the plurality of servers to transmit data between the cloud server and the plurality of servers, and collect and save sent-to-vehicle data and sent-to-server data that are sent/received by the plurality of servers.

15. A dangerous driving vehicle alert server capable of being used in a dangerous driving vehicle alert system that issues alert relating to a potential dangerous driving vehicle to alert-receiving vehicles,
the server comprising:
a server-side communicator that receives sent-to-server data that is transmitted from vehicle-side communicators, which are included in the alert receiving vehicles, at predetermined first timing and transmits sent-to-vehicle data to the vehicle-side communicators of the alert receiving vehicles at predetermined second timing, the sent-to-server data including data of images that is saved in vehicle-side storages, which are included in the alert receiving vehicles, and positional information that is detected by vehicle-side sensors, which are included in the alert-receiving vehicles, and represents image capture positions at which the images are captured; and
a dangerous driving level calculator that analyzes patterns of driving behavior of vehicles to be analyzed that are included in the data of images, which is saved in the vehicle-side storages, based on the sent-to-server data to calculate dangerous driving levels of the vehicles analyzed, and compares the dangerous driving levels calculated of the vehicles to be analyzed with a predetermined value to categorize each vehicle to be analyzed into a dangerous driving vehicle if its dangerous driving level is higher than the predetermined value,
wherein the sent-to-vehicle data includes the dangerous driving level of the dangerous driving vehicle, which is calculated by the dangerous driving level calculator, an identifier of a vehicle registration plate of the dangerous driving vehicle extracted from the data of images, and positional information that represents a position at which an image of the dangerous driving vehicle is captured, and
wherein the dangerous driving level of the dangerous driving vehicle and the identifier of the dangerous driving vehicle, which are included in the sent-to-server data, can be indicated on road maps on the vehicle-side displays of the alert receiving vehicles in accordance the position of the dangerous driving vehicle.

16. A dangerous driving vehicle alert device capable of issuing alert relating to a potential dangerous driving vehicle,
the device comprising:
a vehicle-side sensor that can detect a position of a vehicle to be alerted;
a vehicle-side display that can show a road map of an area around the vehicle to be alerted;
a vehicle-mounted camera that captures images corresponding to an FOV of the vehicle-mounted camera on the vehicle to be alerted;
a vehicle-side storage that saves data of images that are captured by the vehicle-mounted camera; and
a vehicle-side communicator that can transmit sent-to-server data to a server to be used in a dangerous driving vehicle alert system at predetermined first timing and receive sent-to-vehicle data from the server, the sent-to-server data including the data of images, which is saved in the vehicle-side storages, and positional information that is detected by the vehicle-side sensor and represents an image capture position at which the images are captured,
wherein patterns of driving behavior of vehicles to be analyzed that are included in the data of images are analyzed based on the sent-to-server data to calculate dangerous driving levels of the vehicles analyzed so that the dangerous driving levels calculated of the vehicles to be analyzed are compared with a predetermined value to categorize each vehicle to be analyzed into a dangerous driving vehicle if its dangerous driving level is higher than the predetermined value,
wherein the vehicle-side communicator receives the sent-to-vehicle data including the dangerous driving level of the dangerous driving vehicle, an identifier of a vehicle registration plate of the dangerous driving vehicle extracted from the data of images, and positional information that represents a position at which an image of the dangerous driving vehicle is captured, and
wherein the dangerous driving level and the identifier can be indicated on the road map on the vehicle-side display in accordance the position of the dangerous driving vehicle.

17. A dangerous driving vehicle alert method of issuing alert relating to a potential dangerous driving vehicle to a plurality of alert-receiving vehicles,
the method comprising:
saving data of images that are captured by vehicle-mounted cameras that are included in the alert-receiving vehicles in vehicle-side storages that are included in the alert-receiving vehicles;
transmitting sent-to-server data to a server to be used in a dangerous driving vehicle alert system at predetermined first timing, the sent-to-server data including the data of images, which is saved in the vehicle-side storages, and positional information that is detected by vehicle-side sensors that included in the alert-receiving vehicles and represents image capture positions at which the images are captured;
analyzing patterns of driving behavior of vehicles to be analyzed that are included in the data of images based on the sent-to-server data to calculate dangerous driving levels of the vehicles analyzed, and comparing the dangerous driving levels calculated of the vehicles to be analyzed with a predetermined value to categorize each vehicle to be analyzed into a dangerous driving vehicle if its dangerous driving level is higher than the predetermined value by using a dangerous driving level calculator;
transmitting sent-to-vehicle data to vehicle-side communicators of the alert receiving vehicles at predetermined second timing, the sent-to-vehicle data including the dangerous driving level of the dangerous driving vehicle, which is calculated by the dangerous driving level calculator, an identifier of a vehicle registration plate of the dangerous driving vehicle extracted from the data of images, and positional information that represents a position at which an image of the dangerous driving vehicle is captured; and
indicating the dangerous driving level and the identifier of the dangerous driving vehicle, which are included in the sent-to-vehicle data, on road maps, which show areas around the alert receiving vehicles, on the vehicle-side displays of the alert receiving vehicles in accordance the position of the dangerous driving vehicle.

18. A non-transitory computer readable recording medium storing a server program of realizing a dangerous driving vehicle alert system that issues alert relating to a potential dangerous driving vehicle to alert-receiving vehicles,
the program causing a server to execute:
receiving sent-to-server data that is transmitted from vehicle-side communicators, which are included in the alert receiving vehicles, at predetermined first timing, the sent-to-server data including data of images that is saved in the vehicle-side storages, which are included in the alert receiving vehicles, and positional information that is detected by vehicle-side sensors, which are included in the alert-receiving vehicles, and represents image capture positions at which the images are captured;
analyzing patterns of driving behavior of vehicles to be analyzed that are included in the data of images, which is saved in vehicle-side storages included in the alert receiving vehicles, based on the sent-to-server data to calculate dangerous driving levels of the vehicles analyzed, and compares the dangerous driving levels calculated of the vehicles to be analyzed with a predetermined value to categorize each vehicle to be analyzed into a dangerous driving vehicle if its dangerous driving level is higher than the predetermined value; and
transmitting sent-to-vehicle data to vehicle-side communicators of the alert receiving vehicles at predetermined second timing, the sent-to-vehicle data including the dangerous driving level of the dangerous driving vehicle, which is calculated in the analyzing of patterns of driving behavior, an identifier of a vehicle registration plate of the dangerous driving vehicle extracted from the data of images, and positional information that represents a position at which an image of the dangerous driving vehicle is captured whereby indicating the dangerous driving level, and the identifier of the dangerous driving vehicle, which are included in the sent-to-vehicle data, on road maps, which show areas around the alert receiving vehicles, on the vehicle-side displays of the alert receiving vehicles in accordance the position of the dangerous driving vehicle.

19. A non-transitory computer readable recording medium storing a dangerous driving vehicle alert program of issuing alert relating to a potential dangerous driving vehicle,
the program causing a computer to execute:
saving data of images that are captured corresponding to an FOV of a vehicle-mounted camera on the vehicle to be alerted;
transmitting sent-to-server data to a server to be used in a dangerous driving vehicle alert system at predetermined first timing and receiving sent-to-vehicle data from the server, the sent-to-server data including the data of images captured, and positional information that is detected by a vehicle-side sensor, which detects a position of the vehicle to be alerted, and represents an image capture position at which the images are captured;
receiving the sent-to-vehicle data including a dangerous driving level of a dangerous driving vehicle that is calculated based on pattern analysis, an identifier of a vehicle registration plate of the dangerous driving vehicle extracted from the data of images, and positional information that represents a position at which an image of the dangerous driving vehicle is captured, the pattern analysis analyzing patterns of driving behavior of vehicles to be analyzed that are included in the data of images based on the sent-to-server data to calculate dangerous driving levels of the vehicles analyzed so that the dangerous driving levels calculated of the vehicles to be analyzed are compared with a predetermined value to categorize each vehicle to be analyzed into the dangerous driving vehicle if its dangerous driving level is higher than the predetermined value; and
indicating the dangerous driving level and the identifier of the dangerous driving vehicle on a road map, which shows an area around the vehicle to be alerted, on a vehicle-side display in accordance the position of the dangerous driving vehicle in response to the reception of the sent-to-vehicle data from the server through vehicle-side communicator.

20. (canceled)
